(19) United States
(12) Patent Application Publication
(10) Pub. No.: US 2021/0263535 A1
(43) Pub. Date: Aug. 26, 2021

(54) Following Vehicle with a Communication Device, Group of Vehicles, Method for Operating the Following Vehicle, Computer Program and Computer-Readable Storage Medium

(71) Applicant: Continental Automotive GmbH, Hannover (DE)

(72) Inventor: Günter Anton Fendt, München (DE)

(73) Assignee: Continental Automotive GmbH, Hannover (DE)

(21) Appl. No.: 17/255,602

(22) PCT Filed: Jun. 19, 2019
(86) PCT No.: PCT/EP2019/066194

§ 371 Date: Dec. 23, 2020

(30) Foreign Application Priority Data
Jun. 26, 2018 (DE) 10 2018 210 399.2

(51) Int. Cl. G05D 1/02; H04W 4/46

(52) U.S. Cl. CPC G05D 1/0295; G05D 1/0242; G05D 1/028; H04W 4/46

(57) ABSTRACT

Various embodiments of the teachings herein include a vehicle configured to track behind autonomously in a group trailing a leading vehicle comprising: a communication device for receiving first and second vehicle-relevant data, the first vehicle-relevant data and the second vehicle-relevant data redundant to one another; a data transmitting interface for receiving the first vehicle-relevant data via a first wireless transmission medium; and a data receiving interface for receiving the second vehicle-relevant data via a second wireless transmission medium. The first wireless transmission medium is different from the second. The second comprises an optical connection. The data receiving interface receives during the autonomous tracking the second vehicle-relevant data directly from a vehicle in the group driving immediately ahead of the vehicle, and permanently parallel to the first vehicle-relevant data.

### CROSS-REFERENCE TO RELATED APPLICATIONS

This application is a U.S. National Stage Application of International Application No. PCT/EP2019/066194 filed Jun. 19, 2019, which designates the United States of America, and claims priority to DE Application No. 10 2018 210 399.2 filed Jun. 26, 2018, the contents of which are hereby incorporated by reference in their entirety.

### TECHNICAL FIELD

The present disclosure relates to operating vehicles. Various embodiments include a following vehicle with a communication device for receiving first and second vehicle-relevant data, to track behind autonomously in the group on the trail of a leading vehicle, groups of vehicles, methods for operating the following vehicle, computer programs, and/or computer-readable storage medium.

### BACKGROUND

Autonomous vehicles may have several communication interfaces by means of which the vehicles can communicate with one another or with remote central computers or servers. The vehicles usually communicate with one another by radio and this is referred to as car-to-car (vehicle-to-vehicle) communication. Infrastructure facilities may also be involved in this communication. The communication between vehicles and infrastructure facilities is known as car-to-X (vehicle-to-infrastructure) communication.

DE 4133882 A1 describes a method for automatically tracking a vehicle on the trail of a vehicle driving ahead (leading vehicle), with an electronic camera arranged on the vehicle continuously generating image signals for significant rear areas of the leading vehicle, from which the distance measured in the direction of the longitudinal axis of the vehicle between the latter and the leading vehicle and the lateral offset of the same from the longitudinal axis of the vehicle are continuously determined by means of electronic image evaluation, and the required values of the steering angle are calculated.

DE 10 2007 044 936 B4 discloses a vehicle lighting system with a lamp for illumination, lighting or signaling, the emitted light of which can be changed in light intensity, spectral composition or both, starting from an initial value, and can be returned again to the initial value, with first switch-on and switch-off times for which the human eye perceives fluctuations in brightness or fluctuations in color, and with second switch-on and switch-off times, which are significantly shorter, so that the human eye does not perceive any fluctuations in brightness or fluctuations in color, and a switching unit coupled to the lamp, which, within the second switch-on and switch-off times, changes the lamp, depending on a coded signal, in light intensity, spectral composition or both, starting from a starting value and returning again to the starting value.

U.S. Pat. No. 8,078,390 B2 describes a method and a device for carrying out the method with vehicle-relevant information that is received via the communication means and receiving means for determining the location, evaluated using means for coordinating the interaction and reproduced by means for wireless radio networking of mobile devices carried in the vehicle within the displays of these mobile devices.

U.S. Pat. No. 8,352,111 B2 describes a method for controlling multiple vehicles in order to operate the multiple vehicles in a procession, the method comprising: within a leading vehicle selected from the multiple vehicles: monitoring a respective actual position of each of the multiple vehicles other than the leading vehicle by vehicle-to-vehicle communication on the basis of data from a respective global positioning device in each of the multiple vehicles other than the leading vehicle; determining a respective minimum desired distance between the vehicles on the basis of the actual position of each of the multiple vehicles for each of the multiple vehicles; determining a maximum fuel-efficient distance between the vehicles on the basis of the actual position of each of the vehicles for each of the multiple vehicles; and selecting a respective instructed vehicle position for each of the multiple vehicles on the basis of the maximum of the minimum desired inter-vehicle distances for all of the multiple vehicles and the respective maximum fuel-efficient inter-vehicle distance; transmitting each corresponding instructed vehicle position to the respective one of the multiple vehicles other than the leading vehicle; and operating each corresponding one of the multiple vehicles other than the leading vehicle on the basis of the respective instructed vehicle position.

DE 102012208256 A1 describes a system and a method for autonomous tracking of a following vehicle on the trail of a leading vehicle, in which the leading vehicle is controlled by a driver and a leading message is sent from the leading vehicle by means of vehicle-to-X communication indicating readiness for autonomous tracking of following vehicles and including at least an item of vehicle identification information and an item of route information of the leading vehicle. The leading message is received by the following vehicle by means of vehicle-to-X communication and rejected by it or confirmed by it with a following message which includes at least an item of vehicle identification information for the following vehicle. After the following message has been received, the leading vehicle sends first coordination information for coordinating the autonomous tracking to the following vehicle by means of vehicle-to-X communication until the end of the autonomous tracking. Second coordination information for coordinating the autonomous tracking is recorded by means of environment sensors of the following vehicle on the basis of driving movements of the leading vehicle, the first and the second coordination information being compared by the following vehicle, with the autonomous tracking corresponding to the first and second coordination information being performed if there is a matching result of the comparison, and with the autonomous tracking being ended if there is a non-matching result of the comparison.

### SUMMARY

The present disclosure describes a vehicle with a communication device with which reliable communication of autonomous driving of one or more vehicles in succession in road traffic is possible even over a long period of time. For example, some embodiments include a following vehicle (3, 4) with a communication device for receiving first and second vehicle-relevant data, the first vehicle-relevant data and the second vehicle-relevant data being redundant to one another, the following vehicle (3, 4) being able to track behind autonomously in the group on the trail of a leading vehicle (2), with a data transmitting interface for receiving the first vehicle-relevant data via a first wireless transmission medium, with a data receiving interface for receiving the second vehicle-relevant data via a second wireless transmission medium, the first wireless transmission medium being formed differently from the second wireless transmission medium, and the second wireless transmission medium being formed as an optical connection, characterized in that the data receiving interface is designed to receive during the autonomous tracking the second vehicle-relevant data directly from a vehicle in the group driving immediately ahead of the following vehicle (3, 4) tracking behind, and permanently parallel to the first vehicle-relevant data.

In some embodiments, the optical connection is designed as a light connection (10) or an optical directional radio connection or an IF (infrared) connection.

In some embodiments, in normal operation the first vehicle-relevant data and in operation in the event of a fault the second vehicle-relevant data accomplish autonomous driving-in-a-group operation.

In some embodiments, the first wireless transmission medium is formed as a radio connection.

In some embodiments, a front camera (7), which forms the data receiving interface, is provided.

In some embodiments, a data sending interface is provided.

In some embodiments, the data sending interface is formed by at least two rear lights (8) and/or a back light and/or a tail light and/or a reflex reflector.

In some embodiments, at least control data for the longitudinal and lateral guidance of the following vehicle (3, 4) tracking behind are provided as vehicle-relevant data.

As another example, some embodiments include a group of vehicles (1) with at least two following vehicles (3, 4) as described herein, characterized in that the at least two following vehicles (3, 4) track behind in a group on the trail of a leading vehicle (2), the first following vehicle (3) receiving the second vehicle-relevant data directly from the leading vehicle (2) driving ahead during the autonomous tracking via the data receiving interface and the at least second following vehicle (4) receiving the second vehicle-relevant data directly from the following vehicle (3) driving immediately ahead during the autonomous tracking via the data receiving interface.

In some embodiments, a front camera (7), which forms the data receiving interface, is provided and at least two rear lights (8) and/or a back light and/or a tail light and/or a reflex reflector, which form the data sending interface, are provided.

As another example, some embodiments include a method for operating a following vehicle (3, 4) with a communication device for receiving first and second vehicle-relevant data, the first vehicle-relevant data and the second vehicle-relevant data being formed as redundant to one another, the following vehicle (3, 4) tracking behind autonomously in the group on the trail of a leading vehicle (2), characterized by: providing a data transmitting interface for receiving the first vehicle-relevant data via a first wireless transmission medium, providing a data receiving interface for receiving the second vehicle-relevant data via a second wireless transmission medium, the first wireless transmission medium being formed differently from the second wireless transmission medium, and the second wireless transmission medium being formed as an optical connection, and receiving the second vehicle-relevant data permanently parallel to the first vehicle-relevant data directly from a vehicle in the group driving immediately ahead through the data receiving interface during the autonomous tracking.

In some embodiments, a comparison of the first vehicle-relevant data with the second vehicle-relevant data is carried out, with the autonomous tracking being performed if there is a matching result of the comparison and with the autonomous tracking being ended if there is a non-matching result of the comparison.

In some embodiments, in the event of a fault or failure of the first wireless transmission medium or the data transmitting interface, a check is provided as to whether the autonomous driving mode as a following vehicle (3, 4) tracking behind is continued or whether a change to a driving mode as a single vehicle takes place.

In some embodiments, the useful life of the second data is subject to a time limit.

In some embodiments, in normal operation the first vehicle-relevant data are used and in operation in the event of a fault the second vehicle-relevant data are used for autonomous driving operation in a group.

As another example, some embodiments include a computer program which is designed to subsequently add a method as described herein to a vehicle.

As another example, some embodiments include a computer-readable storage medium comprising instructions which, when executed by a computer, cause the computer to perform the methods described herein.

### BRIEF DESCRIPTION OF THE DRAWINGS

Further features, properties, and advantages of various embodiments of the teachings of the present disclosure emerge from the following description with reference to the attached figures, in which, schematically:

FIG. 1: shows a group of vehicles incorporating teachings of the present disclosure, with multiple following vehicles according to the invention, in side view; and

FIG. 2: schematically shows a method incorporating teachings of the present disclosure; and

FIG. 3: shows a group of vehicles incorporating teachings of the present disclosure in plan view.

### DETAILED DESCRIPTION

Some embodiments of the teachings herein include a following vehicle with a communication device for receiving first and second vehicle-relevant data, the first vehicle-relevant data and the second vehicle-relevant data redundant to one another. The following vehicle tracks behind autonomously within the group on the trail of a leading vehicle, with a data transmitting interface for receiving the first vehicle-relevant data via a first wireless transmission medium, and a data receiving interface for receiving the second vehicle-relevant data via a second wireless transmission medium. The first wireless transmission medium is formed differently from the second wireless transmission medium. The second wireless transmission medium is an optical connection.

In some embodiments, the second data receiving interface is designed to receive during the autonomous tracking the second vehicle-relevant data directly from a vehicle in the group driving immediately ahead of the following vehicle tracking behind, and permanently parallel to the first vehicle-relevant data. Leading vehicles offer other vehicles the possibility of autonomously tracking behind the leading vehicle as the following vehicle by issuing a leading message that can be sent by means of a vehicle-to-X communication.

A following vehicle tracking behind is a vehicle autonomously or automatically tracking behind in the trail of the leading vehicle, the leading vehicle by contrast for example controlled by a driver and/or operated in autonomous or semi-autonomous driving mode (not autonomously following a leading vehicle driving ahead). In other words, a following vehicle is autonomously controlled by the driver assistance system as a following vehicle in the group, the expression “on the trail of a leading vehicle” not to be taken literally, but to be understood as meaning that a following vehicle follows a leading vehicle or a vehicle driving ahead within a procession/convoy.

A vehicle in the group means a further following vehicle or the leading vehicle itself. While they are within the group of vehicles, the autonomous vehicles are connected via a communication device. The vehicles can communicate via this communication device and thus form the group of vehicles. The leading vehicle controls the movement of the following vehicles tracking behind or causes vehicle-relevant control data transmitted via car-to-car communication to make the vehicles following within the group track behind accordingly. First and second vehicle-relevant data means control data for autonomous tracking.

The transmission medium means the transmission connection with which data can be transmitted. This may be for example radio, radar, or optical transmission connections such as optical directional radio, in particular light or infrared. The corresponding data receiving interface receives, evaluates, and decrypts the corresponding data.

A permanent parallel data transmission means a permanent synchronous data transmission, the expression “synchronous” not to be taken literally, but to be understood in the sense that the data transmission takes place in a temporal context, for example due to theoretical or practical different transmission rates of the different interfaces. The vehicle-relevant control data from the leading vehicle do not necessarily have to be executed synchronously in the following vehicles, but for example with a certain vehicle speed-dependent time offset, in order to compensate/equalize the distance between the vehicles and the vehicle-speed-dependent distance covered per unit of time, so that ultimately a more precise match of the individual tracks followed by the vehicles is achieved.

By providing a redundant, parallel data transmission through two different wireless transmission media, in the event of a sporadic failure or disruption of the first transmission medium, at least temporary vehicle control within the group of vehicles, based on the vehicle-relevant control data, transmitted via the second transmission medium. It should be noted here that the first and second data are the same data for all of the following vehicles tracking behind of a group.

Thus, although the second data are transmitted directly from the vehicle driving ahead, for example a following vehicle, these data are the same as the first data, just transmitted through a different transmission medium. The following vehicles are therefore supplied in an indirect and direct manner with the same data that are generated by the leading vehicle. In some embodiments, any following vehicle in the group is supplied in an indirect and direct manner with the same data that are generated by the leading vehicle. By contrast with the prior art, it is therefore not necessary for one of the following vehicles to generate the second data from driving movements of the vehicle driving ahead. Since the first data and second data are redundant data, a conversion of the first data into the second data or vice versa is not necessary.

In some embodiments, in the event of a sporadic disruption of the data transmitting interface, for example in a radio-based data transmitting interface, due to jammers or other frequencies that are generated by other systems operating in the same frequency range or by mixed frequencies and harmonics and/or by systems without interference suppression or faulty systems, the second data receiving interface is still available as a substitute for receiving the second redundant data. With the additional second data receiving interface, an alternative communication can take place immediately without loss of time, since the second data receiving interface is already included in the non-fault situation between the vehicles immediately following one another and ensures permanent parallel data transmission. This contributes to more reliable driving safety in the group.

In some embodiments, the optical connection is designed as a light connection or an optical directional radio connection or an infrared (IF) connection. These optical connections may have a very fast connection set-up, high data security, less influence of rain and snow on the transmission and no interference problems.

In normal operation, the first vehicle-relevant data and in operation in the event of a fault the second vehicle-relevant data may accomplish autonomous driving-in-a-group operation. Normal operation means that the data transmitting interface is functional and the following vehicle that is tracking behind receives the first data. Operation in the event of a fault means a fault or failure of the data transmitting interface or of the first transmission medium.

The first data receiving interface may be bidirectional. The second data receiving interface may be at least unidirectional. As a result, the communication protocol can be designed much more simply, which reduces the complexity of communication processing.

In some embodiments, the first wireless transmission medium is formed as a radio connection. This may be for example a WLAN connection or a near-field communication connection. The radio connection allows comparatively secure data transmission at a high data transmission rate.

In some embodiments, there is a front camera which forms the second data receiving interface. In some embodiments, the front camera is used in autonomous operation. The front camera can for example receive the second data as coded signals from a lighting system of the vehicle driving ahead. These coded signals are encoded again by the vehicle tracking behind as second data. For this purpose, the lighting system of the vehicle driving ahead can send out control signals which do not contain any fluctuations in brightness or color that the human eye can perceive. This can be achieved for example by complementary control, in that for example, with active lighting (light switched on), the coding takes place with “brief” low signals and, with inactive lighting (light switched off), the coding takes place with “brief” high signals.

In some embodiments, the following vehicle has a data sending interface. This can be formed by at least two rear lights and/or a back light and/or a tail light and/or a reflex reflector. In some embodiments, at least control data for the longitudinal and lateral guidance of the following vehicle tracking behind are provided as vehicle-relevant data. In some embodiments, the communication device is in a driver assistance system.

In some embodiments, there is a group of vehicles with at least two following vehicles, as described above, the at least two following vehicles tracking behind in a group on the trail of a leading vehicle, the first following vehicle receiving the second vehicle-relevant data directly from the leading vehicle driving ahead during the autonomous tracking via the data receiving interface and the at least second following vehicle receiving the second vehicle-relevant data directly from the following vehicle driving immediately ahead during the autonomous tracking via the data receiving interface. In some embodiments, there is a front camera, which forms the data receiving interface, and at least two rear lights and/or a back light and/or a tail light and/or a reflex reflector, which form the data sending interface. If the first wireless, in particular radio-based, transmission medium fails, the second data are used as a substitute in order to allow the following vehicle to further track behind safely and reliably.

In some embodiments, there is a method for operating a following vehicle, with a communication device for receiving first vehicle-relevant data and second vehicle-relevant data, the first vehicle-relevant data and the second vehicle-relevant data being formed as redundant to one another, the following vehicle autonomously tracking behind on the trail of a leading vehicle in the group, with the steps of:
providing a data transmitting interface for receiving the first vehicle-relevant data via a first wireless transmission medium,
providing a data receiving interface for receiving the second vehicle-relevant data via a second wireless transmission medium, and the first wireless transmission medium being formed differently from the second wireless transmission medium, the second wireless transmission medium being formed as an optical connection,
receiving the second vehicle-relevant data permanently parallel to the first vehicle-relevant data directly from the vehicle in the group driving immediately ahead through the data receiving interface during the autonomous tracking.

In some embodiments, a comparison of the first vehicle-relevant data with the second vehicle-relevant data is carried out, with the autonomous tracking being performed if there is a matching result of the comparison and with the autonomous tracking being ended if there is a non-matching result of the comparison. This contributes to improved safety of the method. In the event of a fault or failure of the first wireless transmission medium or the data transmitting interface, a check may be provided as to whether the autonomous driving mode as a following vehicle tracking behind is continued or whether a change to a driving mode as a single vehicle takes place.

A check means whether the second data can be used to ensure safe and reliable tracking of the following vehicle. For this purpose, for example, the permanent reliable transmission of the second data is necessary.

An autonomous single vehicle means that state in which the vehicles do not form a group of vehicles and the vehicle drives in a partially autonomous or autonomous mode of operation. Semi-autonomous means that the driver assistance system takes over one or more driving functions of the driver. A driving function may be understood here as meaning steering, accelerating, braking or, if necessary, gear selection. Autonomous means that the driver assistance system essentially executes all driving functions. In some embodiments, a change to a driving mode as a single vehicle, in which the driver partially or completely takes over the driving tasks, may also take place, for example in the case when there is a defect or a fault of the camera in the following vehicle, and as a result the second wireless transmission medium does not work reliably.

In some embodiments, the useful life of the second data may be subject to a time limit. The useful life is understood here as meaning the period of time in which the tracking of the following vehicle takes place on the basis of the second data. A time limit means that the vehicle is not permanently made to continue as a following vehicle tracking behind based solely on the second data. This increases driving safety in the group. The time period in which a failure of the first data, for example due to a fault or failure of the first transmission medium and/or the data transmitting interface, is compensated for by using the second data is for example set in advance in the communication device. If the use of the second data exceeds the previously set period of time, the system switches to single vehicle operation, that is to say driving in a group is ended.

In some embodiments, in normal operation the first vehicle-relevant data are used and in operation in the event of a fault the second vehicle-relevant data are used for autonomous driving operation in a group.

In some embodiments, there is a computer program comprising instructions which, when the program is executed by the computer, cause the computer to perform the methods as described herein. The computer program subsequently adds a method as described above to an autonomous vehicle. This subsequent addition can for example be carried out externally by the vehicle manufacturer. In some embodiments, the vehicle manufacturer can implement the method during vehicle manufacture.

In some embodiments, a computer-readable storage medium comprising instructions which, when executed by the computer, cause the computer to perform the methods as described herein.

Although the teachings herein have been described and illustrated in more detail by means of the exemplary embodiments, the scope of the teachings is not limited by the disclosed examples. Variations thereof may be derived by a person skilled in the art without departing from the scope of disclosure.

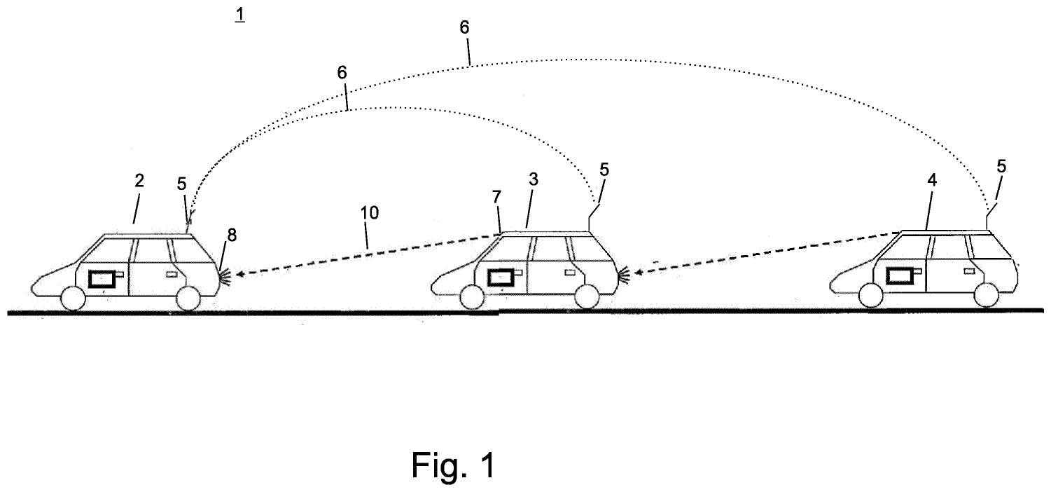

FIG. 1 shows a group of vehicles 1 with a leading vehicle 2 and two following vehicles 3, 4 tracking behind on the trail of the leading vehicle 1. In this case, the following vehicle 3 follows the leading vehicle 2 and the following vehicle 4 follows the following vehicle 3. The vehicles 2, 3, 4 incorporating teachings of the present disclosure each have a data transmitting interface, which is formed here in a simplified manner as an antenna 5. The leading vehicle 1 transmits first vehicle-relevant data by means of the antenna 5 and a first wireless transmission medium, here a radio connection 6, both to the antenna 5 of the second following vehicle and to the antenna 5 of the third following vehicle 4. The vehicle-relevant data in this case comprise control data for the longitudinal and lateral guidance of the following vehicles 3, 4 tracking behind. The radio connection 6 is in this case formed as a bidirectional data interface.

Furthermore, each of the vehicles 2, 3, 4 has an optical data receiving interface, which is formed here as a front camera 7, such a front camera 7 usually being used in any case. Use of the front camera 7 as an optical data receiving interface does not however adversely affect its original function. Furthermore, each vehicle 2, 3, 4 has an optical data sending interface, which here are the rear lights 8.

The front camera 7 and the rear lights 8 of the vehicle driving ahead form the unidirectional optical data transmitting interface. The second wireless transmission medium is designed as a light connection 10, in particular as an optical directional radio connection, light or IF (infrared) connection. By means of the front camera 7, the second data can be received from the rear lights 8 of the vehicle driving ahead via the second wireless transmission medium.

For this purpose, the light emitted by the rear lights 8 transmits the second data in a correspondingly coded manner. This coding can be carried out for example in the form of fluctuations in brightness or color which do not impair the original function of the vehicle's lighting system.

This unidirectional optical data transmitting interface formed by the rear lights 8 and the front camera 7 has a very fast set-up. In addition, the optical data transmitting interface has a high level of data security, little influence of rain and snow on the transmission and no interference problems. This can be achieved with complementary control, in that for example with active lighting (light switched on) the coding takes place with “brief” low signals (“light-off signals”) and with inactive lighting (light switched off) the coding takes place with “brief” high signals (“light-on signals”).

During operation of the group of vehicles 1, the second data are transmitted permanently parallel to the first data, that is to say synchronously or in a temporal relationship. This means that the optical connection between the vehicles in each case immediately following one another is already set up in the non-fault situation. The first and second data are therefore transmitted redundantly to the following vehicles 3, 4 tracking behind.

In normal operation of the vehicle group 1, that is to say that there is no disturbance in the radio connection 6, the first data are used to establish and maintain the tracking.

If the radio connection 6 fails briefly, for example due to a failure of one of the antennas 5, for example the electronic components required for the radio connection, or due to a disturbance in the radio connection 6 due to for example jamming transmitters, the second data can be accessed immediately and without loss of time in order to maintain the autonomous vehicle guidance in a group. Thus, sporadic disturbances of the radio-based communication can be temporally bridged by means of the second data, so that not every sporadically occurring disturbance leads to a disturbance of the entire vehicle group.

Furthermore, the redundantly transmitted first and second data are compared with one another. The first data are thereby verified by the second data. If there is a non-matching result of the comparison, the tracking is ended for a short time or driving-in-a-group operation is not enabled. If there is a matching result of the comparison, the autonomous tracking is carried out or continued. This contributes to increased driving safety.

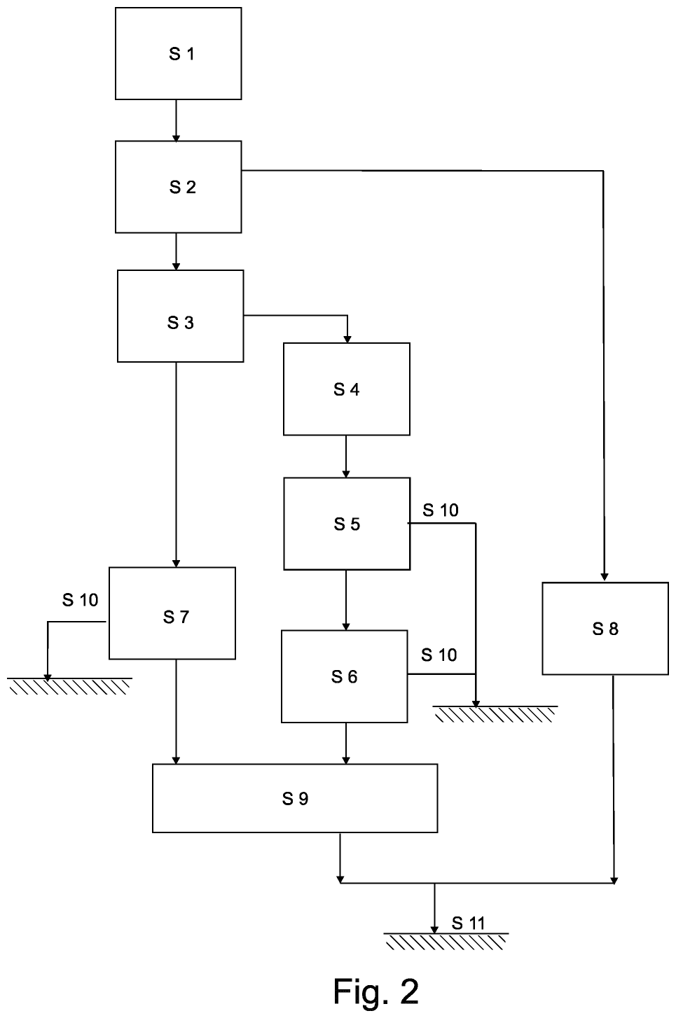

FIG. 2 shows a method incorporating teachings of the present disclosure in a first embodiment. Here, in a first step S1, a vehicle is put into operation by the driver. In a second step S2, it is determined whether the vehicle is being operated in an autonomous or partially autonomous mode of operation. If the vehicle is in an autonomous or partially autonomous mode of operation, in a further step S3 it is checked whether the vehicle is being operated as a following vehicle 3, 4 tracking behind.

If the vehicle 1 is to be operated as a following vehicle 3, 4 tracking behind, a leading vehicle 2 sends first data and second data to the following vehicle 3, 4 to be made to track behind. These data include at least control data for longitudinal and lateral guidance of the following vehicle 3, 4 tracking behind.

In this case, the first data are sent via the bidirectional radio connection 6. The second data are sent via the unidirectional optical data transmitting interface. In this case, the front camera 7 of the following vehicle 3, 4 tracking behind acts as a data receiving interface and the rear lights 8 of the following vehicle 3 driving ahead or of the leading vehicle 2 act as a data sending interface.

The first and second received data are compared by the following vehicle 3, 4 tracking behind. Only after a matching result of the comparison is the following vehicle 3, 4 made to track behind. In a step S7, the vehicle 3, 4 is made to track behind.

In driving-in-a-group operation, the first and second data are sent permanently in parallel, here synchronously. Furthermore, the first and second data are redundant to one another. In normal operation, that means without disturbance of the radio connection 6, the first and second data are permanently compared. If the comparison results match, the tracking of the following vehicle 3, 4 is continued in a step S9.

If there is a non-matching result of the comparison, autonomous tracking is ended and driving in a group is ended in step S10. It is possible to switch to partially autonomous/autonomous single driving operation or to manual driving operation.

If a fault or failure of the radio connection 6 (FIG. 1) occurs in a step S4, it is checked whether the second data can ensure safe continuation of autonomous driving-in-a-group operation. If the second data can be used to continue autonomous tracking, then driving operation is continued with these second data in a step S 5. This continuation is in this case temporally limited to a certain period of time. In a step S6, it is checked whether the continuation of the autonomous tracking based on the second data is still within this time period. If the continuation of the autonomous tracking is still within the time period, the autonomous tracking is continued in step S9 on the basis of the second data.

If the continuation of the autonomous tracking lies outside the time period or if the second data cannot be used for the tracking, driving in a group is ended in step S10. It is possible to switch to partially autonomous/autonomous single driving operation or to manual driving operation. The duration may be taken here from an existing database.

Thus, sporadic disturbances of the radio-based data transmitting interface or disturbances of the radio connection can be bridged by means of the second data, so that not every sporadically occurring disturbance leads to a disturbance of the entire group of vehicles. If the vehicle is not in a partially autonomous or autonomous operating mode, the vehicle is in the manual operating mode S8 and is controlled manually by the driver.

The method is ended when the journey is ended in a step S11.

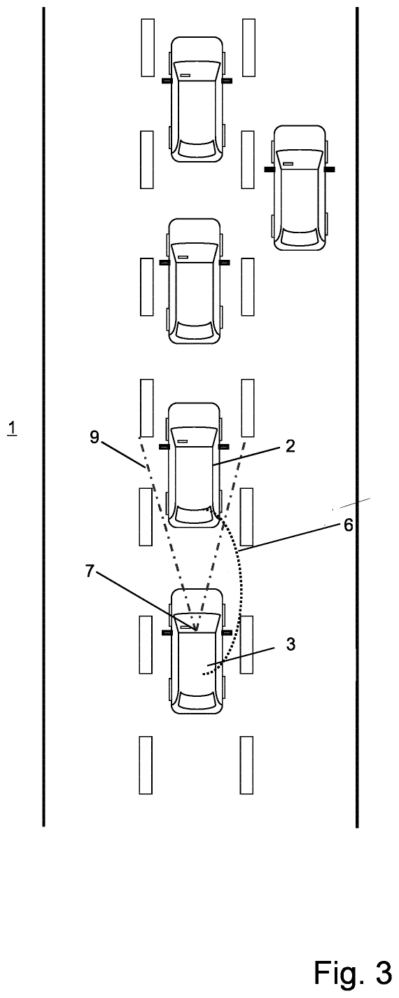

FIG. 3 shows a further embodiment of a group of vehicles 1 incorporating teachings of the present disclosure with a leading vehicle 2 and a following vehicle 3 tracking behind, in plan view. Here the group of vehicles 1 is guided in the middle of three lanes. The first transmission medium is designed as a radio connection 6. The optical data receiving interface is formed as a front camera 7; the optical data sending interface is formed as rear lights 8 of the leading vehicle 2 driving ahead. The front camera 7 has in this case a sending/receiving angle 9, which optically detects the rear lights 8 of the leading vehicle 2 driving ahead. The sending/receiving angle 9 ensures reliable reception of the second data.

### LIST OF REFERENCE SIGNS

1 Group of vehicles

2 Leading vehicle

3 First following vehicle tracking behind

4 Second following vehicle tracking behind

5 Antenna

6 Radio connection

7 Front camera

8 Rear lights

9 Sending/receiving angle

10 Light connection

S Method steps

What is claimed is:

1. A vehicle configured to track behind autonomously in a group trailing a leading vehicle, the vehicle comprising:
a communication device for receiving first and second vehicle-relevant data, the first vehicle-relevant data and the second vehicle-relevant data redundant to one another;
a data transmitting interface for receiving the first vehicle-relevant data via a first wireless transmission medium; and
a data receiving interface for receiving the second vehicle-relevant data via a second wireless transmission medium;
wherein the first wireless transmission medium is different from the second wireless transmission medium and the second wireless transmission medium comprises an optical connection;
the data receiving interface receives during the autonomous tracking the second vehicle-relevant data directly from a vehicle in the group driving immediately ahead of the vehicle, and permanently parallel to the first vehicle-relevant data.

2. The vehicle as claimed in claim 1, wherein the optical connection comprises a light connection or an optical directional radio connection or an IF connection.

3. The vehicle claimed in claim 1, wherein, during normal operation, the first vehicle-relevant data and the second vehicle-relevant data are independently sufficient to perform autonomous driving-in-a-group operation.

4. The vehicle as claimed in claim 1, wherein the first wireless transmission medium comprises a radio connection.

5. The following vehicle as claimed in claim 1, wherein the data receiving interface comprises a front-facing camera.

6. The vehicle as claimed in claim 1, further comprising a data sending interface.

7. The vehicle as claimed in claim 6, wherein the data sending interface comprises at least two rear lights and/or a back light and/or a tail light and/or a reflex reflector.

8. The vehicle as claimed in claim 1, wherein the vehicle-relevant data includes at least control data for the longitudinal and lateral guidance of the vehicle.

9. A group of vehicles comprising:
at least two vehicles as claimed in claim 1; wherein:
the at least two vehicles track behind in a group on the trail of a leading vehicle;
a first of the at least two vehicles receives the second vehicle-relevant data directly from the leading vehicle via the data receiving interface; and
a second of the at least two vehicles receives the second vehicle-relevant data directly from the first of the at least two vehicles driving immediately ahead during the autonomous tracking via the data receiving interface.

10. The group of vehicles as claimed in claim 9, further comprising:
a front camera for each vehicle comprising the data receiving interface;
the respective data sending interface for each vehicle includes at least two rear lights and/or a back light and/or a tail light and/or a reflex reflector.

11. A method for operating a following vehicle with a communication device for receiving first and second vehicle-relevant data, the first vehicle-relevant data and the second vehicle-relevant data being formed as redundant to one another, the following vehicle tracking behind autonomously in a group on the trail of a leading vehicle, the method comprising:
receiving the first vehicle-relevant data via a first wireless transmission medium;
receiving the second vehicle-relevant data via a second wireless transmission medium, the first wireless transmission medium being comprising a different medium from the second wireless transmission medium, and the second wireless transmission medium being formed as an optical connection; and
receiving the second vehicle-relevant data permanently parallel to the first vehicle-relevant data directly from a vehicle in the group driving immediately ahead through the data receiving interface during the autonomous tracking.

12. The method for operating a following vehicle as claimed in claim 11, further comprising comparing the first vehicle-relevant data with the second vehicle-relevant data; and,
performing the autonomous tracking being performed if there is a matching result of the comparison; and
ending the autonomous tracking if there is a non-matching result of the comparison.

13. The method for operating a following vehicle as claimed in claim 11, further comprising, in the event of a fault or failure of the first wireless transmission medium or the data transmitting interface, checking whether the autonomous driving mode as a following vehicle tracking behind is continued or whether a change to a driving mode as a single vehicle takes place.

14. The method for operating a following vehicle as claimed in claim 11, wherein a useful life of the second data is subject to a time limit.

15. The method for operating a following vehicle as claimed in claim 11, further comprising:
using in normal operation the first vehicle-relevant data; and
in operation in the event of a fault using the second vehicle-relevant data.

16-17. (canceled)
